(19) United States
(12) Patent Application Publication
(10) Pub. No.: US 2016/0024366 A1
(43) Pub. Date: Jan. 28, 2016

(54) HEAT-DISSAPATING POWDER COATING COMPOSITION, HEAT-DISSIPATING COATING FILM, AND COATED ARTICLE

(71) Applicant: PELNOX, LTD., Kanagawa (JP)

(72) Inventors: Eiji IWAMURA, Osaka (JP); Masaki KOBAYASHI, Ibaraki (JP); Hirofumi KOMIYAMA, Kanagawa (JP); Naoya TAKAHASHI, Kanagawa (JP)

(21) Appl. No.: 14/770,447

(22) PCT Filed: Feb. 25, 2014
(86) PCT No.: PCT/JP2014/054523

§ 371 Date: Aug. 25, 2015

(30) Foreign Application Priority Data
Mar. 2, 2013 (JP) 2013-041340
May 7, 2013 (JP) 2013-097840

(51) Int. Cl. C09K 5/14; C08K 3/26; C08K 3/16; C08K 3/22; C09D 163/00; C08K 7/26

(52) U.S. Cl. CPC C09K 5/14; C09D 163/00; C08K 7/26; C08K 3/16; C08K 3/22; C08K 3/26; C08K 2003/162; C08K 2003/2241; C08K 2003/265

(57) ABSTRACT

A powdered paint composition for heat dissipation according to one aspect of the present invention contains at least one binder resin (A) selected from the group consisting of an epoxy resin (a1) and a polyester resin (a2) having a hydroxy group and/or a carboxyl group and also contains a heat dissipation filler (B) having a thermal conductivity of 0.2 W/mK or more and less than 100 W/mK in an amount of 10 mass % or more and 40 mass % or less. The powdered paint composition for heat dissipation can be used as a material for forming a coating film having excellent efficiency of heat dissipation on the surfaces of various articles.

### TECHNICAL FIELD

The present invention relates to a powdered paint composition for heat dissipation that can form a coating film having excellent heat dissipation, for example, on heat-generating parts in various types of electrical and electronic equipment, a thermal emission coating film formed from the composition, and a coated object having the coating film.

### BACKGROUND ART

Conventionally, thermal management in electrical and electronic equipment has been considered very important. For example, electric power consumption per electronic device component significantly increases with increasing performance of consumer electronics or more compact and denser assemblies of portable devices, and increasing speed of microprocessors. This results in largely increased heat generation from electronic device components, which easily leads to deterioration of the devices to cause degraded performance of the entire products including the devices.

In recent daily life and industry, energy saving or active introduction of alternative natural energy tends to expand the markets of LED light bulbs and solar cells every year. Such electrical and electronic equipment, however, involves intensive energy to improve the brightness or the concentration of light, causing the electrical and electronic equipment itself to have very high temperatures during use. In the production of the electrical and electronic equipment, measures for heat dissipation are generally implemented in component modules or finished products.

Conventionally, measures for heat dissipation have generally depended on convection because of its simplicity and high efficiency of heat dissipation. For this reason, attempts have been made in which heat dissipating fins are set on the upper surfaces of semiconductor devices (e.g., LSI, power IC) in various types of modules used in, for example, semiconductor devices to dissipate the heat generated from semiconductor devices to outside environments through the effect of convection by heat dissipating fins (see Patent Documents 1 and 2).

In the case of LED light bulbs, disclosed is means for conducting thermal energy generated from a light emitting diode being a heat source to a high thermal conductive heat sink made of, for example, aluminum or copper to dissipate the thermal energy from the surface of the heat sink to the outside through natural convection or forced convection using a cooling fan (see Patent Document 3).

### PRIOR ART DOCUMENT

### Patent Documents

Patent Document 1: JP H06-209057 A

Patent Document 2: JP H06-132433 A

Patent Document 3: JP 2004-055229 A

### SUMMARY OF INVENTION

### Problems to be Solved by the Invention

In the heat dissipation means based on the physical structure as described above, it is important to increase the surface area as much as possible and change the atmosphere (air) of outside environment as often as possible in order to increase the efficiency of heat dissipation. It is also effective to use materials, such as aluminum or copper, having very high thermal conductivity as a heat sink and transport as much heat as possible from an internal heat source to the outermost surface (heat dissipating surface) of the physical heat dissipation means as quickly as possible.

However, downsizing modules or integrated products makes it difficult to ensure the space for installation of internal heat dissipating fins, cooling fans, or the like. When the weight reduction, cosmetics, economical efficiency, portability, or other properties of such modules or integrated products are considered, the use of metal with heavy weight such as aluminum or copper is also limited. In addition, the temperature at which general electrical and electronic equipment requires measures for heat dissipation is at most 200° C., and usually far lower temperature than 200° C., therefore, the heat dissipation effect attributed to convection is constrained. In this field, there is thus an increasing need for the optimum thermal management in combination of convection, thermal conduction, and radiation. Application of powdered paint compositions for heat dissipation to housings for integrated products and/or the surface of each discrete component is considered as an effective measure for achieving such a heat dissipation design.

As used herein, the term “measures for heat dissipation” refers to designing the optimum means in combination of each heat transfer means such as thermal conduction, convection, and heat radiation in order to transport and release thermal energy from a heat source (high temperature region) in electrical and electronic equipment to outside low temperature regions.

As used herein, the term “powdered paint composition” refers to a mixture of a heat dissipation filler (inorganic particles) with a binder resin, wherein the mixture is free of volatile components and is solid powder at room temperature. The term “powdered paint composition for heat dissipation” refers to a powdered paint composition that can actively dissipate heat by itself through the thermal conductivity or heat radiation.

In order to improve the heat dissipation effect of the coating film, it is necessary to increase the efficiency of transporting the thermal energy from an internal heat source to the surface of the coating film through a base. Therefore, various types of ceramic particles with high thermal conductivity are considered suitable as a heat dissipation filler or a filling material for thermal emission coating films. In terms of the thermal conductivity, for example, JP H02-133450 A describes that aluminum nitride (thermal conductivity: 100 W/mK or more) used as a heat dissipating material has a higher thermal conductivity than alumina (aluminum oxide), silica, or the like by one or more digits. Aluminum nitride thus seems to be preferred. However, not only the thermal conductivity but also chemical properties need to be taken into consideration for heat dissipation fillers. Since aluminum nitride, which is reactive with moisture in the air, possibly degrades binder resins in paints with time as also mentioned in the above patent publication, aluminum nitride may be unsuitable for a thermal emission coating film.

Since liquid or paste paint compositions for heat dissipation contain various solvents (e.g., organic solvents), the health of workers who apply the paint compositions to targets for coating film formation needs to be cared. Such liquid or paste paint compositions cannot be applied to objects to be coated having solubility with organic solvents, whereas aqueous solvents may impose problems of corrosion, insulation defects, and the like. In addition, it is also relatively difficult to achieve uniform coating in a wider area. In contrast, powdered paint compositions can easily form a thick film of more than several microns in a short time and can provide relatively uniform coating on a large area or uneven base. Furthermore, powdered paint compositions have a few restrictions on objects to be coated and cause relatively small problems associated with reliability, such as corrosion or insulation defects. Therefore, there is a strong industrial need for safer, more useful powdered paint compositions for heat radiation that replace liquid paint compositions.

### Solution to Problems

As described above, powdered paint compositions for heat dissipation show advantageous effects over liquid or paste paint compositions, but production of powdered paint compositions from existing liquid or paste paint compositions is not easy. The present inventors have found several technical problems in the process of repeated trials and errors and solved them in order to obtain a powdered paint composition. Specifically, the amount of heat released from the surface of a coating film formed from a powdered paint composition for heat dissipation per unit area or unit time largely depends on the thickness of the coating film, and a smaller thickness of the coating film results in higher efficiency of transporting thermal energy. The present inventors have focused on the point that the thickness of the coating film of a heat-dissipating paint is at most several tens of micrometers, which is thinner than the thickness (millimeter order) of heat dissipating members, such as aluminum heat dissipating fins, by nearly two or more digits. According to intensive studies and analysis based on such a point of view, the present inventors have found that a powdered paint for heat dissipation excellent in the performances of the coating film, such as heat dissipation, adhesion, and weather resistance, and/or the coating properties as a powdered paint can be obtained by employing a predetermined material as a binder resin to be combined with a powdered paint composition for heat dissipation without using a highly thermally conductive filler, such as aluminum nitride.

The binder resin is more preferably capable of not only improving the heat dissipation of the coating film, but also ensuring the adhesion with the base, the mechanical strength, or the wettability of the melted powdered paint composition to the base.

As a result of further analysis and study, the present inventors have found that a paint composition that can simultaneously solve all of the above-mentioned problems is obtained by combination of heat dissipation fillers having a relatively small thermal conductivity with a predetermined binder resin. As a result, a novel powdered paint composition for heat dissipation that can serve as a starting material for a coating film excellent in heat dissipation and/or adhesion and mechanical strength has been created without using a highly thermally conductive filler, such as aluminum nitride.

A powdered paint composition for heat dissipation according to one aspect of the present invention includes at least one binder resin (A) selected from the group consisting of an epoxy resin (a1) and a polyester resin (a2) having a hydroxy group and/or a carboxyl group and also includes an heat dissipation filler (B) having a thermal conductivity of more than 0.2 W/mK and less than 100 W/mK in an amount of 10 mass % or more and 40 mass % or less. Other aspects of the present invention are a thermal emission coating film obtained from the powdered paint composition for heat dissipation, and a coated object covered with the thermal emission coating film.

The powdered paint composition for heat dissipation can form a coating film as a powdered paint having excellent efficiency of heat dissipation on the surfaces of various materials. It should be particularly noted that combination of heat dissipation fillers having a relatively small thermal conductivity with a predetermined binder resin allows the powdered paint composition for heat dissipation to serve as a material for a coating film having excellent efficiency of heat dissipation as described above. Since a coating film obtained from the powdered paint composition for heat dissipation, in other words, a coating film obtained by using the powdered paint composition for heat dissipation as a starting material has good efficiency of heat dissipation, the coating film is particularly suitable for equipment and components used in spaces with limited air flow, such as sealed housing, or compact module components that cannot incorporate the structure of heat sinks or heat dissipating fins. The coating film obtained from this paint composition can be used in products requiring measures for heat dissipation, such as solar cells, organic EL lighting devices or drivers, thereby contributing to the reliability and/or stable operation of various types of devices.

### Effects of the Invention

The powdered paint composition for heat dissipation according to one aspect of the present invention can be used as a material for forming a coating film having excellent efficiency of heat dissipation on the surfaces of various articles. Since the coating film according to one aspect of the present invention obtained from the powdered paint composition for heat dissipation has good efficiency of heat dissipation, the coating film is particularly suitable for equipment and components used in spaces with limited air flow, such as sealed housing, or compact module components that cannot incorporate the structure of heat sinks or heat dissipating fins. This coating film has excellent adhesion with a base, particularly a metal base and can achieve high hardness, high heat resistance and/or high weather resistance. The coating film can be thus used in products requiring measures for heat dissipation, such as solar cells, organic EL lighting devices or drivers, thereby contributing to the reliability and/or stable operation of various types of devices.

### BRIEF DESCRIPTION OF THE DRAWING

FIG. 1 is a schematic diagram illustrating a method of evaluating the heat dissipation of a coating film in one embodiment according to the present invention.

### MODE FOR CARRYING OUT THE INVENTION

A powdered paint composition for heat dissipation according to this embodiment includes at least one binder resin (A) (hereinafter also referred to as a component (A)) selected from the group consisting of an epoxy resin (a1) (hereinafter also referred to as a component (a1)) and a polyester resin (a2) (hereinafter also referred to as a component (a2)) having a hydroxy group and/or a carboxyl group and also includes an heat dissipation filler (B) (hereinafter also referred to as a component (B)) having a thermal conductivity of more than 0.2 W/mK and less than 100 W/mK in an amount of 10 mass % or more and 40 mass % or less. This powdered paint composition for heat dissipation is powdered paint and thus substantially free of organic solvents (see Japanese Industrial Standards (JIS)—K 5000: 2000). According to further study and analysis, the component (a1) has been found to contribute to improvements in adhesion and heat resistance among various types of effects exerted by the powdered paint composition for heat dissipation. In addition, the component (a2) has been found to contribute to an improvement in weather resistance among various types of effects exerted by the powdered paint composition for heat dissipation. Therefore, the powdered paint composition for heat dissipation containing both the component (a1) and the component (a2) is a more preferred aspect because these components can exert their respective advantageous effects with higher accuracy.

Typical examples of the component (a1) according to this embodiment include various known epoxy resins. Specifically, bisphenol-type epoxy resins and/or novolac-type epoxy resins are preferred in terms of the heat dissipation of the coating film, the adhesion with a base, and the like. Typical examples of bisphenols forming the bisphenol-type epoxy resins include bisphenol A, bisphenol F, bisphenol AD, bisphenol S, tetramethyl bisphenol A, tetramethyl bisphenol F, tetramethyl bisphenol AD, tetramethyl bisphenol S, tetrabromo bisphenol A, tetrachloro bisphenol A, and tetrafluoro bisphenol A. Typical examples of the novolac-type epoxy resin include phenolic novolac resins, and/or novolac-type epoxy resins obtained by reaction of resol novolac resins with haloepoxides.

The physical properties of the component (a1) are not particularly limited. However, a typical epoxy equivalent is normally about 70 or more and 2500 or less, and the softening point thereof is normally about 60° C. or higher and 150° C. or lower.

Typical examples of the component (a2) according to this embodiment include polyester resins containing a hydroxy group and/or carboxyl group in the molecules, and various known polyester resins may be employed. More specific examples of the component (a2) include polyester resins that are formed by reaction of various known polybasic acids with polyhydric alcohols and have a residual hydroxy group and/or carboxyl group in the molecules.

Typical examples of the polybasic acids according to this embodiment include various aromatic dicarboxylic acids, aliphatic dicarboxylic acids, and alicyclic dicarboxylic acids, such as phthalic acid, isophthalic acid, terephthalic acid, tetrahydrophthalic acid, tetrahydroterephthalic acid, 2,6-naphthalene dicarboxylic acid, 2,7-naphthalene dicarboxylic acid, hexahydrophthalic acid, hexahydroisophthalic acid, hexahydroterephthalic acid, HET acid, trimellitic acid, hexahydrotrimellitic acid, pyromellitic acid, cyclohexanetetracarboxylic acid, 1,4-cyclohexanedicarboxylic acid, methyltetrahydrophthalic acid, methylhexahydrophthalic acid, endomethylenehexahydrophthalic acid, methylendomethylenetetrahydrophthalic acid, maleic acid, fumaric acid, itaconic acid, succinic acid, glutaric acid, adipic acid, azelaic acid, sebacic acid, decanedicarboxylic acid, dodecanedicarboxylic acid, suberic acid, pimelic acid, dimer acid (dimer of tall oil fatty acid), tetrachlorophthalic acid, naphthalene dicarboxylic acid, 4,4′-diphenylmethanedicarboxylic acid, and 4,4′-dicarboxybiphenyl; and their acid anhydrides, and their dialkyl esters (particularly dimethyl esters). In addition to these, lactones, such as γ-butyrolactone and ε-caprolactone, and hydroxycarboxylic acids corresponding to these lactones, aromatic oxymonocarboxylic acids, such as p-oxyethoxy benzoic acid, and the like can be used.

Typical examples of the polyhydric alcohols according to this embodiment include dihydric or higher alcohols, such as ethylene glycol, propylene glycol, 1,2-propanediol, 1,3-propanediol, 1,2-butanediol, 1,3-butanediol, 1,4-butanediol, 2,3-butanediol, 1,2-butanediol, 1,2-pentanediol, 1,5-pentanediol, 1,4-pentanediol, 2,3-pentanediol, 2,4-pentanediol, 2,3-dimethyltrimethylene glycol, 3-methyl-pentane-1,5-diol, 3-methyl-1,5-pentanediol, 3-methyl-4,5-pentanediol, 2,2,4-trimethyl-1,3-pentanediol, 1,6-hexanediol, 1,5-hexanediol, 1,4-hexanediol, 2,5-hexanediol, 1,4-cyclohexane dimethanol, diethylene glycol, dipropylene glycol, 1,2-dodecanediol, 1,2-octadecanediol, triethylene glycol, neopentyl glycol, neopentyl glycol hydroxy pivalate, polyalkylene oxide, bishydroxyethyl terephthalate, an alkylene oxide adduct of (hydrogenated) bisphenol A, an alkylene oxide adduct of (hydrogenated) bisphenol S, glycerol, trimethylolpropane, trimethylolethane, diglycerol, pentaerythritol, dipentaerythritol, and sorbitol.

The hydroxy value (JIS K 0070) of the component (a2) according to this embodiment is not particularly limited. However, the hydroxy value is normally about 10 mg KOH/g or more and 100 mg KOH/g or less. The acid value (JIS K 0070) according to this embodiment is not also particularly limited. However, the acid value is normally about 10 mg KOH/g or more and 100 mg KOH/g or less. Other physical properties are not also particularly limited, and for example, the softening point is normally about 100° C. or higher and 200° C. or lower.

When the component (a1) and the component (a2) are used together as the component (A), the mixing ratio of these components is not particularly limited, but the number of moles of the epoxy group of the component (a1) may be in the range of about 0.5 mol or more and 1.5 mol or less, given that the number of moles of the hydroxy group in the component (a2) is 1.

The thermal conductivity of the component (A) is not particularly limited, but normally 1 W/mK or less, specifically about 0.15 W/mK or more and 0.5 W/mK or less.

The powdered paint composition according to this embodiment may contain various known hardening agents as desired in order to cause a crosslinking reaction of the component (A). Specifically, when the component (a1) is used as the component (A) according to this embodiment, hardening agents for epoxy resins, such as phenolic hardening agents, (e.g., bisphenol-A type phenolic resin), triazines, dicyandiamide, adipic acid, imidazole compounds, amine-based hardening agents, and aromatic acid anhydrides, can be added to the powdered paint composition. In addition, hardening accelerators, such as tertiary amines, tertiary amine salts, imidazoles, phosphines, and phosphonium salts, can also be added as desired.

When the component (a2) is used as the component (A), examples of hardening agents reactive with a hydroxy group include trimers of various known diisocyanates (e.g., a trimer of ε-caprolactam blocked isophorone diisocyanate) and various known polyisocyanate compounds. Specific examples of the diisocyanates include aromatic diisocyanates, such as tolylene diisocyanate, diphenylmethane diisocyanate, and xylylene diisocyanate; aliphatic diisocyanates, such as hexamethylene diisocyanate, trimethyl hexamethylene diisocyanate, and lysine diisocyanate; hydrogenated xylene diisocyanates, such as dicyclohexylmethane diisocyanate, isophorone diisocyanate, and 1,4-cyclohexane diisocyanate; and alicyclic diisocyanates, such as hydrogenated tolylene diisocyanate. Examples of hardening agents reactive with a carboxyl group include various known hardening agents having a glycidyl group, or vinyl ether group, hydroxy group, amino group, or other groups in the molecules.

The amount of these hardening agents used may be in the range of normally about 0.5 mol or more and 1.5 mol or less, given that the number of moles of the epoxy group in the component (a1) is 1 mol, the number of moles of the hydroxy group in the component (a2) is 1 mol, or the total of the number of moles of the epoxy group in the component (a1) and the number of moles of the hydroxy group in the component (a2) is 1 mol.

The component (B) according to this embodiment can be any known heat dissipation filler that has a thermal conductivity of 0.2 W/mK or more and less than 100 W/mK without limitation. A specific example of the component (B) is at least one selected from the group consisting of silicon oxide particulates, fluorometal crystal particulates, boron nitride particulates, quartz particulates, kaolin particulates, aluminum hydroxide particulates, bentonite particulates, talc particulates, salicide particulates, forsterite particulates, mica particulates, cordierite particulates, and the like. In this embodiment, selecting the component (A) as a binder resin can provide a powdered paint composition for heat dissipation having excellent heat dissipation even using the component (B) having a lower thermal conductivity than aluminum nitride. This allows the coating film obtained from the powdered paint composition for heat dissipation to have good efficiency of heat dissipation, and thus the composition can be applied to, for example, equipment and components used in spaces with limited air flow, such as sealed housing, or compact module components that cannot incorporate the structure of heat sinks or heat dissipating fins.

Since materials having a thermal conductivity of more than 100 W/mK are generally considered to belong to semiconductors or electrically good conductors, the thermal conductivity of the component (B) is less than 100 W/mK, more preferably about 80 W/mK or less to ensure the electrical insulation with higher accuracy for use in electrical and electronic equipment. The lower limit of the thermal conductivity of the component (B) is preferably 0.2 W/mK or more in order to obtain a powdered paint composition for heat dissipation having excellent heat dissipation with higher accuracy. In this embodiment, selecting a suitable component (B) that can be employed in combination with the component (A) (i.e., the component (a1) and/or the component (a2)) can achieve a powdered paint for heat dissipation excellent in the performances of the coating film, such as heat dissipation, adhesion, and weather resistance, and/or the coating properties as a powdered paint, as described above.

A typical example of the component (B) is preferably at least one selected from the group consisting of mica particulates, forsterite particulates, silicon oxide particulates, fluorometal crystal particulates, and boron nitride particulates as described above, particularly in order to increase the heat dissipation of the coating film. In addition, silicon oxide particulates and/or fluorometal crystal particulates are particularly preferred in terms of the efficiency of heat dissipation at relatively low to moderate temperatures of from about 40° C. to 100° C. in electronic devices or the like. Furthermore, fluorometal crystal particulates are preferred in terms of the coating properties, and boron nitride particulates are preferred in terms of the efficiency of heat dissipation in a relatively high temperature range of over 100° C.

A typical example of production of the silicon oxide particulates according to this embodiment includes first mixing sodium silicate and sulfuric acid using high-purity silica sand as a raw material to form silicate sol. The silicate sol is then polymerized to form an aggregate, which is then gelated to produce silicon oxide particulates (see, for example, JP H09-071723 A). Other known production methods may also be employed. The silicon oxide particulates thus produced may be porous or non-porous. Specific examples of commercially available products include Sylysia 730, Sylysia 740, Sylysia 770, Sylysia 530, Sylysia 540, and Sylysia 550 available from Fuji Silysia Chemical Ltd.

Typical examples of the fluorometal crystal particulates according to this embodiment include lithium fluoride, calcium fluoride, barium fluoride, and magnesium fluoride. Of these, calcium fluoride and magnesium fluoride are particularly suitable materials in terms of the durability, particularly the durability against thermal shock, or the like. In another aspect of the present invention, two or more of specific examples of the fluorometal crystal particulates described above may be also used together as the fluorometal crystal particulates according to this embodiment.

When the silicon oxide particulates and the fluorometal crystal particulates are used together in this embodiment, the mass percentage ratio of the silicon oxide particulates to the fluorometal crystal particulates is preferably adjusted to about 1:4 to about 4.9:5.1 (silicon oxide particulates : fluorometal crystal particulates). This adjustment of the mass ratio may provide the effects of improving the coating properties and also improving the cosmetics of the coating film in appearance.

The particle size of the component (B) is not particularly limited. However, the average primary particle size of the component (B) is preferably about 0.1 μm or more and 50 μm or less, more preferably 1 μm or more and 50 μm or less, in consideration of the mechanical strength of the coating film formed, the cosmetics (smoothness), and/or the efficiency of heat dissipation based on proper unevenness of the coating film. The median diameter D50 of the component (B) is not also particularly limited. However, the median diameter D50 of the component (B) is typically preferably 50 μm or less, more preferably 40 μm or less.

In another aspect of the present invention, the powdered paint composition for heat dissipation according to this embodiment may be used as a colored powdered paint by incorporating a color pigment (C) (hereinafter also referred to as a component (C)) into the paint composition according to this embodiment as desired in consideration of the cosmetics or the like.

Various known materials can be used as the component (C) according to this embodiment without limitation. An example of the component (C) is at least one selected from the group consisting of titanium oxide powder, carbon black powder, and iron oxide powder. The thermal conductivity of the component (C) is not particularly limited. However, the thermal conductivity of the component (C) is normally about 1 W/mK or more and 30 W/mK or less.

In addition, the shape of the component (C) is not also particularly limited. However, the average primary particle size of the component (C) is preferably normally in the range of about 0.01% or more and 10% or less of the average primary particle size of the component (B) described above in view of at least one of the mechanical strength of the coating film, the cosmetics (smoothness), and the efficiency of heat dissipation based on proper unevenness of the coating film. The average primary particle size of the component (C) is not also particularly limited. However, the average primary particle size of the component (C) is normally preferably 1 μm or less.

The content of the component (A) in the powdered paint composition for heat dissipation according to this embodiment is not particularly limited. In a preferred aspect of the present invention, however, the content of the component (A) is in the range of 30 mass % or more and 85 mass % or less of the total mass of the powdered paint composition in order to improve the coating properties of the powdered paint composition and the adhesion of the powdered paint composition to the base with higher accuracy and ensure more effective heat dissipation. In a more preferred aspect of the present invention, the content of the component (A) is in the range of 30 mass % or more and 70 mass % or less in the same point of view. In an extremely preferred aspect of the present invention, the content of the component (A) is in the range of 35 mass % or more and 70 mass % or less in the same point of view.

The content of the component (C) in the powdered paint composition for heat dissipation according to this embodiment is not particularly limited, either. In other words, an aspect may be employed in which the component (C) is not contained. However, the content of the component (C) is preferably about 0.5 mass % or more and 30 mass % or less, in order to improve the mechanical strength for use as a coating film, the cosmetics such as concealment, and/or the efficiency of heat dissipation based on proper unevenness of the coating film. In addition, the content of the component (C) is more preferably about 1 mass % or more and 25 mass % or less, still more preferably 5 mass % or more and 25 mass % or less.

In another aspect of the present invention, the paint composition according to this embodiment may appropriately contain at least one additive selected from the group consisting of matting agents, leveling agents, surface control agents (e.g., acrylic-based), extenders (e.g., calcium carbonate), fillers, coupling agents, lubricants, ultraviolet absorbers, waxes, and the like.

The powdered paint composition according to this embodiment can be produced by a melt mixing process, a dry blending process, or other ordinary or known processes. For example, a melt mixing process involves dry-blending the component (A), the component (B), and optionally at least one selected from the group consisting of hardening agents, hardening accelerators, additives, and the like using a Henschel mixer or the like. The resulting mixture is then melt mixed with, for example, a kneader or an extruder. The material mixture is then solidified by cooling, followed by fine grinding and subsequent size classification to produce the powdered paint according to the this embodiment. The particle size of the powdered paint according to this embodiment is not particularly limited. However, the average primary particle size of the powdered paint normally falls within the range of about 5 μm or more and 250 μm or less. The above production method provides a paint composition for use as a starting material of a coating film that is formed on the surfaces of various bases and has excellent heat dissipation and/or adhesion, mechanical strength, coating properties, and wettability of melted powdered paint composition to the base.

To form the thermal emission coating film according to this embodiment, the powdered paint composition for heat dissipation according to this embodiment is applied to various types of exothermic bases being targets to be coated. More specifically, the powdered paint composition for heat dissipation may be softened or melted by heating on the base and then hardened to form a thermal emission coating film according to this embodiment. The application means described above is not particularly limited. For example, a fluidized bed coating process, an electrostatic-fluidized bed process, an electrostatic spray process, a cascade welding sequence, or other processes can be employed as application means.

A hardened coating film is obtained by coating with the powdered paint for heat dissipation according to this embodiment, then heating a coated object being an exothermic article and having the coating film to soften or melt the coating film, and then hardening the coating film. The heat conditions are not particularly limited, but the temperature is normally about 120° C. or higher and 220° C. or lower, and the time is about 5 minutes or more and 1 hour or less. The thickness of the hardened coating film is not particularly limited. However, the thickness is normally about 5 μm or more and 500 μm or less. In addition, the type of the base is not also particularly limited. However, examples of the bases normally include iron, aluminum, copper, and alloys thereof, and other heat resistant materials. The shape of the base is not also particularly limited. In an aspect of the present invention, the base may be, for example, plate-shaped, fin-shaped, rod-shaped, or coil-shaped.

### EXAMPLES

The above embodiment will be described below in more detail by way of Examples. However, the above embodiment is not limited by Examples. The unit “part” is on a mass basis.

### (Blank Test)

To the surface of a metal base (aluminum plate, size: about 120 mm long×about 50 mm wide×about 2 mm thick), a resistor device (SHUNT resistor device, available from PCN Corporation, model: PBH 1Ω D, rated power: 10 W, size: about 2 cm long×about 1.5 cm wide×about 0.5 cm thick) as a heat source was fixed with a commercially available thermally conductive double-sided tape (trade name: No. 5046 thermally conductive tape, available from Maxell Sliontec Ltd.). The temperature of the measurement atmosphere was set to 25° C. A constant electric current (3.2 A) was applied to the SHUNT resistor device so that the temperature of the SHUNT resistor device was raised to 100° C., and the temperature was stabilized.

### Example 1

To the surface of the metal base above, a powdered paint was applied which was composed of 32 parts of a commercially available bisphenol-A type epoxy resin (*1), 3 parts of a commercially available o-cresol novolac-type epoxy resin (*4), 8 parts of a commercially available bisphenol-A type phenolic resin (*8), 6 parts of commercially available porous silica powder (*11), 16 parts of commercially available calcium fluoride powder (*12), 20 parts of commercially available titanium oxide powder (*13), 13 parts of commercially available heavy calcium carbonate (*14), and 1 part of a commercially available acrylic surface control agent. Specifically, a coating film formed from the powdered paint on the surface of the metal base was softened or melted by heating under the condition of about 140° C. for about 15 minutes and then hardened to prepare a test base having an exoergic hardened coating film (about 30 μm). The products labeled with the mark * will be described below in more detail.

### (Evaluation on Heat Dissipation of Coating Film)

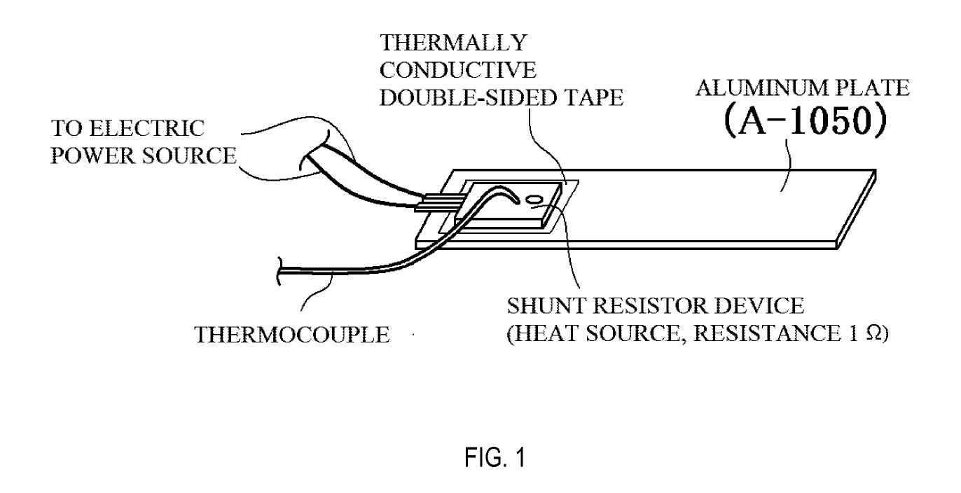

Next, the SHUNT resistor device was fixed to the back side of the test base prepared in Example 1 with the above thermally conductive double-sided tape, as shown in FIG. 1. The temperature of the measurement atmosphere was set to 25° C., and the temperature of the SHUNT resistor device was then measured while a constant electric current (3.2 A) was applied to the SHUNT resistor device. As a result, the SHUNT resistor device was found to have a lower temperature than the reference temperature (100° C.) of the metal base itself by 11.9° C. In Tables 1 and 2, the temperatures lower than the reference temperature are expressed by “negative” values.

The infrared emissivity of the coating film of the test base prepared in Example 1 was measured with a commercially available thermography (trade name: Thermo GEAR G100, available from NEC Avio Infrared Technologies Co., Ltd.) to find that the infrared emissivity was 0.96.

### (Evaluation on Adhesiveness of Coating Film: Cross-Cut Test)

The adhesiveness of the coating film on the baked plate according to Example 1 was evaluated in accordance with the cross-cut test defined in JIS D 0202. Specifically, a grid of 100 squares was made on the surface of the coating film with a cutter knife. A commercially available adhesive tape was stuck to the surface and then allowed to stand for 1 to 2 minutes. The adhesive tape was vertically peeled and the level of the residual coating film was visually evaluated in accordance with the following criteria. The evaluation results are shown in Table 1. The baked plates of other Examples and Comparative Examples described below were treated and evaluated in the same manner. The results of Comparative Examples are shown in Table 2.

1: Excellent adhesion (residual level: 95% or more and 100% or less)

2: Fair adhesion (residual level: 65% or more and less than 95%)

3: Poor adhesion (residual level: less than 65% to complete peeling)

In order to further examine the heat resistance of the coating films of Example 1 and other Examples, the adhesiveness was measured in the same manner as described above after heating the coating films at 85° C. and 120° C. for 2000 hours. The heat resistance after heating was evaluated in accordance with the following criteria based on the adhesion. The results of Examples are shown in Table 1, and the results of Comparative Examples are shown in Table 2.

1: Excellent heat resistance (adhesion) (residual level: 95% or more and 100% or less)

2: Fair heat resistance (adhesion) (residual level: 65% more and less than 95%)

3: Poor heat resistance (adhesion) (residual level: less than 65% to complete peeling)

### (Evaluation on Hardness of Coating Film)

The evaluation was based on the pencil hardness test in JIS K 5400. First, the surface of each of the coating films was scratched with pencils having a hardness of 9H to 6B using a predetermined jig, and the hardness of the pencil capable of scratching the surface of each of the coating films was determined. The evaluation criterion was as follows: the pencil hardness decreases in the order of 9H, 8H, 7H, 6H, 5H, 4H, 3H, 2H, H, F, HB, B, 2B, 3B, 4B, 5B, and 6B, and when the pencil hardness was determined to be B or higher, it was then evaluated as practically acceptable. The results of Examples are shown in Table 1, and the results of Comparative Examples are shown in Table 2.

### (Evaluation on Weather Resistance)

The evaluation was based on the accelerated weathering test in JIS K 5600. The weather resistance was evaluated in accordance with the following criteria by visually comparing an unexposed coating film and a coating film after 3000 hours from exposure to a sunshine weatherometer using a xenon lamp. The results of Examples are shown in Table 1, and the results of Comparative Examples are shown in Table 2.

1. No changes were found in surface state or the like

2. Obvious coloring and cracks were locally found

3. Coloring and cracks were found on the entire surface

In the above evaluation results, the levels of 2 or higher were evaluated as practically acceptable.

### Examples 2 to 16, Comparative Examples 1 to 8

The raw materials and their parts used in Examples 2 to 16 and Comparative Examples 1 to 8 are shown in Table 1 and Table 2. Heat-dissipating paints were prepared in the same manner as in Example 1 except that the raw materials and their parts shown in Table 1 and Table 2 were employed. After preparing the test bases, the heat dissipation of the coating films on the test bases was evaluated in the same manner as in Example 1.

TABLE 1

| | | | EXAM- | EXAM- | EXAM- | EXAM- | EXAM- | EXAM- | EXAM- | EXAM- | EXAM- |
|---|---|---|---|---|---|---|---|---|---|---|---|
| | | | PLE 1 | PLE 2 | PLE 3 | PLE 4 | PLE 5 | PLE 6 | PLE 7 | PLE 8 | PLE 9 |
| (A) | (a1) | BISPHENOL-A TYPE EPOXY RESIN (*1) | 32 | 0 | 0 | 0 | 0 | 0 | 32 | 32 | 32 |
| | | BISPHENOL-A TYPE EPOXY RESIN (*2) | 0 | 0 | 0 | 38.5 | 38.5 | 0 | 0 | 0 | 0 |
| | | BISPHENOL-A TYPE EPOXY RESIN (*3) | 0 | 0 | 0 | 0 | 0 | 34 | 0 | 0 | 0 |
| | | O-CRESOL NOVOLAC TYPE | 3 | 0 | 0 | 0 | 0 | 0 | 3 | 3 | 3 |
| | | EPOXY RESIN (*4) | | | | | | | | | |
| | (a2) | HYDROXY GROUP CONTAINING | 0 | 85 | 85 | 0 | 0 | 0 | 0 | 0 | 0 |
| | | POLYESTER RESIN (*5) | | | | | | | | | |
| | | HYDROXY GROUP CONTAINING | 0 | 0 | 0 | 61.5 | 61.5 | 0 | 0 | 0 | 0 |
| | | POLYESTER RESIN (*6) | | | | | | | | | |
| | | CARBOXYL GROUP-CONTAINING | 0 | 0 | 0 | 0 | 0 | 66 | 0 | 0 | 0 |
| | | POLYESTER RESIN (*7) | | | | | | | | | |

| | | | | | | | | | | |
|---|---|---|---|---|---|---|---|---|---|---|
| HARD- | BISPHENOL-A TYPE PHENOLIC RESIN (*8) | 8 | 0 | 0 | 0 | 0 | 0 | 8 | 8 | 8 |
| ENING | BLOCKED ISOCYANATE | 0 | 15 | 15 | 0 | 0 | 0 | 0 | 0 | 0 |
| AGENT | HARDENING AGENT (*9) | | | | | | | | | |
| | TRIAZINE HARDENING AGENT (*10) | | 0 | 0 | 0.3 | 0.3 | 0 | 0 | 0 | 0 |
| (B) | POROUS SILICA POWDER (*11) | 6 | 7 | 6 | 8 | 7 | 7 | 0 | 0 | 0 |
| | CALCIUM FLUORIDE POWDER (*12) | 16 | 20 | 16 | 21 | 15 | 20 | 22 | 0 | 0 |
| | BORON NITRIDE (*16) | 0 | 0 | 0 | 0 | 0 | 0 | 0 | 22 | 0 |
| | MICA (*17) | 0 | 0 | 0 | 0 | 0 | 0 | 0 | 0 | 22 |
| | FORSTERITE (*18) | 0 | 0 | 0 | 0 | 0 | 0 | 0 | 0 | 0 |
| (C) | TITANIUM OXIDE POWDER (*13) | 20 | 20 | 20 | 20 | 20 | 20 | 20 | 20 | 20 |
| ADDI- | HEAVY CALCIUM CARBONATE (*14) | 13 | 0 | 15 | 0 | 15 | 0 | 13 | 13 | 13 |
| TIVE | ACRYLIC SURFACE CONTROL AGENT (*15) | 1 | 1 | 1 | 1 | 1 | 1 | 1 | 1 | 1 |
| MASS % | COMPONENT (A) (%) | 35.4 | 57.4 | 53.8 | 66.5 | 63.2 | 67.6 | 35.4 | 35.4 | 35.4 |
| | COMPONENT (B) (%) | 22.2 | 18.5 | 13.9 | 19.3 | 13.9 | 18.2 | 22.2 | 22.2 | 22.2 |
| | COMPONENT (C) (%) | 20.2 | 13.7 | 12.7 | 13.3 | 12.6 | 13.5 | 20.2 | 20.2 | 20.2 |

| | | | | | | | | | |
|---|---|---|---|---|---|---|---|---|---|
| TEMPERATURE DIFFERENCE (Δ° C.) | −11.9 | −11.3 | −11.0 | −11.4 | −11.2 | −11.8 | −11.7 | −11.2 | −11.4 |
| INFRARED EMISSIVITY OF COATING FILM | 0.96 | 0.95 | 0.95 | 0.95 | 0.95 | 0.95 | 0.95 | 0.95 | 0.95 |
| ADHESION | 1 | 1 | 1 | 1 | 1 | 1 | 1 | 1 | 1 |
| HEAT RESISTANCE | 1 | 2 | 2 | 1 | 1 | 1 | 1 | 1 | 1 |
| HARDNESS | F | F | F | HB | HB | HB | F | F | F |
| WEATHER RESISTANCE | 2 | 1 | 1 | 1 | 1 | 1 | 2 | 2 | 2 |

| | | | EXAM- | EXAM- | EXAM- | EXAM- | EXAM- | EXAM- | EXAM- |
|---|---|---|---|---|---|---|---|---|---|
| | | | PLE 10 | PLE 11 | PLE 12 | PLE 13 | PLE 14 | PLE 15 | PLE 16 |
| (A) | (a1) | BISPHENOL-A TYPE EPOXY RESIN (*1) | 32 | 0 | 0 | 32 | 32 | 0 | 0 |
| | | BISPHENOL-A TYPE EPOXY RESIN (*2) | 0 | 38.5 | 38.5 | 0 | 0 | 5 | 0 |
| | | BISPHENOL-A TYPE EPOXY RESIN (*3) | 0 | 0 | 0 | 0 | 0 | 0 | 25 |
| | | O-CRESOL NOVOLAC TYPE | 3 | 0 | 0 | 3 | 3 | 0 | 0 |
| | | EPOXY RESIN (*4) | | | | | | | |
| | (a2) | HYDROXY GROUP CONTAINING | 0 | 0 | 0 | 0 | 0 | 0 | 0 |
| | | POLYESTER RESIN (*5) | | | | | | | |
| | | HYDROXY GROUP CONTAINING | 0 | 61.5 | 61.5 | 0 | 0 | 95 | 0 |
| | | POLYESTER RESIN (*6) | | | | | | | |
| | | CARBOXYL GROUP-CONTAINING | 0 | 0 | 0 | 0 | 0 | 0 | 95 |
| | | POLYESTER RESIN (*7) | | | | | | | |

| | | | | | | | | |
|---|---|---|---|---|---|---|---|---|
| HARD- | BISPHENOL-A TYPE PHENOLIC RESIN (*8) | 8 | 0 | 0 | 8 | 8 | 0 | 0 |
| ENING | BLOCKED ISOCYANATE | 0 | 0 | 0 | 0 | 0 | 0 | 0 |
| AGENT | HARDENING AGENT (*9) | | | | | | | |
| | TRIAZINE HARDENING AGENT (*10) | 0 | 0.3 | 0.3 | 0 | 0 | 0.3 | 0.3 |
| (B) | POROUS SILICA POWDER (*11) | 0 | 0 | 0 | 0 | 0 | 8 | 5 |
| | CALCIUM FLUORIDE POWDER (*12) | 0 | 22 | 0 | 16 | 39 | 21 | 14 |
| | BORON NITRIDE (*16) | 0 | 0 | 22 | 0 | 0 | 0 | 0 |
| | MICA (*17) | 0 | 0 | 0 | 0 | 0 | 0 | 0 |
| | FORSTERITE (*18) | 22 | 0 | 0 | 0 | 0 | 0 | 0 |
| (C) | TITANIUM OXIDE POWDER (*13) | 20 | 20 | 20 | 20 | 20 | 20 | 3 |
| ADDI- | HEAVY CALCIUM CARBONATE (*14) | 13 | 15 | 15 | 13 | 13 | 0 | 0 |
| TIVE | ACRYLIC SURFACE CONTROL AGENT (*15) | 1 | 1 | 1 | 1 | 1 | 1 | 1 |
| MASS % | COMPONENT (A) (%) | 35.4 | 63.2 | 63.2 | 36.6 | 30.2 | 66.5 | 80.9 |
| | COMPONENT (B) (%) | 22.2 | 13.9 | 13.9 | 17.2 | 33.6 | 19.3 | 12.8 |
| | COMPONENT (C) (%) | 20.2 | 12.6 | 12.6 | 21.5 | 17.2 | 13.3 | 5.4 |

| | | | | | | | |
|---|---|---|---|---|---|---|---|
| TEMPERATURE DIFFERENCE (Δ° C.) | −11.2 | −11.8 | −11.4 | −11.0 | −12.2 | −11.5 | −11.0 |
| INFRARED EMISSIVITY OF COATING FILM | 0.95 | 0.95 | 0.95 | 0.95 | 0.96 | 0.95 | 0.95 |
| ADHESION | 1 | 1 | 1 | 1 | 1 | 1 | 1 |
| HEAT RESISTANCE | 1 | 1 | 1 | 1 | 1 | 2 | 2 |
| HARDNESS | F | H | H | H | 2H | F | HB |
| WEATHER RESISTANCE | 2 | 1 | 1 | 2 | 2 | 1 | 1 |

TABLE 2

| | | | COMPAR- | COMPAR- | COMPAR- | COMPAR- |
|---|---|---|---|---|---|---|
| | | | ATIVE | ATIVE | ATIVE | ATIVE |
| | | | EXAMPLE 1 | EXAMPLE 2 | EXAMPLE 3 | EXAMPLE 4 |
| (A) | (a1) | BISPHENOL-A TYPE EPOXY RESIN (*1) | 32 | 0 | 0 | 0 |
| | | BISPHENOL-A TYPE EPOXY RESIN (*2) | 0 | 0 | 0 | 38.5 |
| | | BISPHENOL-A TYPE EPOXY RESIN (*3) | 0 | 0 | 0 | 0 |
| | | O-CRESOL NOVOLAC TYPE EPOXY RESIN (*4) | 3 | 0 | 0 | 0 |
| | (a2) | HYDROXY GROUP CONTAINING | 0 | 85 | 85 | 0 |
| | | POLYESTER RESIN (*5) | | | | |
| | | HYDROXY GROUP CONTAINING | 0 | 0 | 0 | 61.5 |
| | | POLYESTER RESIN (*6) | | | | |
| | | CARBOXYL GROUP-CONTAINING | 0 | 0 | 0 | 0 |
| | | POLYESTER RESIN (*7) | | | | |
| HARD- | | BISPHENOL-A TYPE PHENOLIC RESIN (*8) | 8 | 0 | 0 | 0 |
| ENING | | BLOCKED ISOCYANATE | 0 | 15 | 15 | 0 |
| AGENT | | HARDENING AGENT (*9) | | | | |
| | | TRIAZINE HARDENING AGENT (*10) | 0 | 0 | 0 | 0.3 |
| (B) | | POROUS SILICA POWDER (*11) | 0 | 0 | 0 | 0 |
| | | CALCIUM FLUORIDE POWDER (*12) | 0 | 0 | 0 | 0 |
| (C) | | TITANIUM OXIDE POWDER (*13) | 20 | 30 | 20 | 30 |
| ADDI- | | HEAVY CALCIUM CARBONATE (*14) | 13 | 0 | 15 | 0 |
| TIVE | | ACRYLIC SURFACE CONTROL AGENT (*15) | 1 | 1 | 1 | 1 |
| MASS % | | COMPONENT (A) (%) | 45.5 | 64.9 | 62.5 | 76.2 |
| | | COMPONENT (B) (%) | 0 | 0 | 0 | 0 |
| | | COMPONENT (C) (%) | 26 | 22.9 | 14.7 | 22.8 |
| TEMPERATURE DIFFERENCE (Δ° C.) | | | −10.4 | −9.8 | −9.5 | −9.9 |
| INFRARED EMISSIVITY OF COATING FILM | | | 0.95 | 0.94 | 0.94 | 0.94 |
| ADHESION | | | 1 | 1 | 1 | 1 |
| THERMAL RESISTANCE | | | 1 | 2 | 2 | 1 |
| HARDNESS | | | HB | HB | B | HB |
| WEATHER RESISTANCE | | | 2 | 1 | 1 | 2 |
| | | | COMPAR- | COMPAR- | COMPAR- | COMPAR- |
| | | | ATIVE | ATIVE | ATIVE | ATIVE |
| | | | EXAMPLE 5 | EXAMPLE 6 | EXAMPLE 7 | EXAMPLE 8 |
| (A) | (a1) | BISPHENOL-A TYPE EPOXY RESIN (*1) | 0 | 0 | 0 | 0 |
| | | BISPHENOL-A TYPE EPOXY RESIN (*2) | 38.5 | 0 | 11.5 | 38.5 |
| | | BISPHENOL-A TYPE EPOXY RESIN (*3) | 0 | 34 | 0 | 0 |
| | | O-CRESOL NOVOLAC TYPE EPOXY RESIN (*4) | 0 | 0 | 0 | 0 |
| | (a2) | HYDROXY GROUP CONTAINING | 0 | 0 | 0 | 0 |
| | | POLYESTER RESIN (*5) | | | | |
| | | HYDROXY GROUP CONTAINING | 61.5 | 0 | 18.5 | 61.5 |
| | | POLYESTER RESIN (*6) | | | | |
| | | CARBOXYL GROUP-CONTAINING | 0 | 66 | 0 | 0 |
| | | POLYESTER RESIN (*7) | | | | |

| | | | | | |
|---|---|---|---|---|---|
| HARD- | BISPHENOL-A TYPE PHENOLIC RESIN (*8) | 0 | 0 | 0 | 0 |
| ENING | BLOCKED ISOCYANATE | 0 | 0 | 0 | 0 |
| AGENT | HARDENING AGENT (*9) | | | | |
| | TRIAZINE HARDENING AGENT (*10) | 0.3 | 0 | 0.3 | 0.3 |
| (B) | POROUS SILICA POWDER (*11) | 0 | 0 | 18 | 3 |
| | CALCIUM FLUORIDE POWDER (*12) | 0 | 0 | 32 | 4 |
| (C) | TITANIUM OXIDE POWDER (*13) | 20 | 20 | 10 | 20 |
| ADDI- | HEAVY CALCIUM CARBONATE (*14) | 20 | 0 | 0 | 0 |
| TIVE | ACRYLIC SURFACE CONTROL AGENT (*15) | 1 | 1 | 1 | 1 |
| MASS % | COMPONENT (A) (%) | 70.8 | 82.6 | 32.9 | 77.9 |
| | COMPONENT (B) (%) | 0 | 0 | 50.0 | 5 |
| | COMPONENT (C) (%) | 14.2 | 16.5 | 11.0 | 15.6 |

| | | | | |
|---|---|---|---|---|
| TEMPERATURE DIFFERENCE (Δ° C.) | −9.8 | −10.3 | −12.2 | −9.6 |
| INFRARED EMISSIVITY OF COATING FILM | 0.94 | 0.94 | 0.96 | 0.94 |
| ADHESION | 1 | 1 | 3 | 1 |
| THERMAL RESISTANCE | 1 | 1 | 3 | 1 |
| HARDNESS | HB | HB | H | B |
| WEATHER RESISTANCE | 2 | 2 | 1 | 2 |

### <Description of Products>

*1 . . . Trade name “Epotohto YD-014”, available from Nippon Steel & Sumikin Chemical Co., Ltd., epoxy equivalent: 950, softening point: 97° C.

*2 . . . Trade name “Epotohto YD-012”, available from Nippon Steel & Sumikin Chemical Co., Ltd., epoxy equivalent: 650, softening point: 80° C.

*3 . . . Trade name “jER 1002”, Mitsubishi Chemical Corporation, epoxy equivalent: 650, softening point: 78° C.

*4 . . . Trade name “EPICLON N-675”, available from DIC Corporation

*5 . . . Trade name “FINEDIC M-8020”, available from DIC Corporation, hydroxy value: 30, softening point: 110° C.

*6 . . . Trade name “U-Pica coat GV-820”, available from Japan U-Pica Company, Ltd., hydroxy value: 38, softening point: 113° C.

*7 . . . Trade name “U-Pica coat GV-230”, available from Japan U-Pica Company, Ltd., acid value: 53, softening point: 121° C.

*8 . . . Trade name “jER Cure 171N”, available from Mitsubishi Chemical Corporation

*9 . . . Trade name “VESTAGON B-1530”, available from Evonik Degussa Japan Co., Ltd, a trimer of ε-caprolactam blocked isophorone diisocyanate

*10 . . . Trade name “CUREZOL C11Z”, available from Shikoku Chemicals Corporation, 2,4-diamino-6-[2′-undecylimidazolyl-(1)]-ethyl-s-triazine

*11 . . . Trade name “Sylysia 470”, available from Fuji Silysia Chemical Ltd., thermal conductivity: 1.1 W/m, average primary particle size: 14.1 μm

*12 . . . Trade name “Fluorite Powder Calcium Fluoride”, available from China Tuhsu Flavours & Fragrances Import & Export Co. Ltd., thermal conductivity: 9.7 W/m, average primary particle size: 38.0 μm

*13 . . . Trade name “TITONE R-32”, available from Sakai Chemical Industry Co., Ltd., thermal conductivity: 21 W/m, average primary particle size: 0.2 μm

*14 . . . Trade name “SL-100”, available from Takehara Chemical Industrial Co., Ltd., average primary particle size: 6.0 μm

*15 . . . Trade name “Resiflow P-67”, available from Estron Chemical

*16 . . . Trade name “BORONID S3”, available from ESK Ceramics, thermal conductivity: 60 W/m, average primary particle size: about 10 μm

*17 . . . Trade name “PDM-8DF”, available from Topy industries, limited, thermal conductivity: 0.67 W/m, average primary particle size: about 12 μm

*18 . . . Trade name “FF-200M40”, available from Marusu Glaze Co., Ltd., thermal conductivity: 5 W/m, average primary particle size: about 2.5 μm

What is claimed is:

1. A powdered paint composition for heat dissipation, comprising:
at least one binder resin (A) selected from the group consisting of an epoxy resin (a1) and a polyester resin (a2) having a hydroxy group and/or a carboxyl group; and
a heat dissipation filler (B) having a thermal conductivity of 0.2 W/mK or more and less than 100 W/mK in an amount of 10 mass % or more and 40 mass % or less.

2. The powdered paint composition for heat dissipation according to claim 1, wherein a content of the binder resin (A) is 30 mass % or more and 85 mass % or less.

3. The powdered paint composition for heat dissipation according to claim 1, wherein the component (a1) is a bisphenol-type epoxy resin and/or novolac-type epoxy resin.

4. The powdered paint composition for heat dissipation according to claim 1, wherein the component (B) is at least one selected from the group consisting of mica particulates, forsterite particulates, silicon oxide particulates, fluorometal crystal particulates, and boron nitride particulates.

5. The powdered paint composition for heat dissipation according to claim 1, wherein the component (B) has an average primary particle size of 0.1 μm or more and 50 μm or less.

6. The powdered paint composition for heat dissipation according to claim 1, further comprising a color pigment (C).

7. The powdered paint composition for heat dissipation according to claim 6, wherein the component (C) is at least one selected from the group consisting of titanium oxide powder, carbon black powder, and iron oxide powder.

8. The powdered paint composition for heat dissipation according to claim 6, wherein a content of the component (C) is 0.5 mass % or more and 30 mass % or less.

9. A thermal emission coating film obtained from the powdered paint composition for heat dissipation according to claim 1.

10. A coated object covered with the exoergic coating film according to claim 9.

11. The powdered paint composition for heat dissipation according to claim 2, wherein the component (a1) is a bisphenol-type epoxy resin and/or novolac-type epoxy resin.

12. The powdered paint composition for heat dissipation according to claim 2, wherein the component (B) is at least one selected from the group consisting of mica particulates, forsterite particulates, silicon oxide particulates, fluorometal crystal particulates, and boron nitride particulates.

13. The powdered paint composition for heat dissipation according to claim 2, wherein the component (B) has an average primary particle size of 0.1 μm or more and 50 μm or less.

14. The powdered paint composition for heat dissipation according to claim 2, further comprising a color pigment (C).

15. The powdered paint composition for heat dissipation according to claim 14, wherein the component (C) is at least one selected from the group consisting of titanium oxide powder, carbon black powder, and iron oxide powder.

16. The powdered paint composition for heat dissipation according to claim 14, wherein a content of the component (C) is 0.5 mass % or more and 30 mass % or less.

17. An exoergic coating film obtained from the powdered paint composition for heat dissipation according to claim 2.

18. A coated object covered with the exoergic coating film according to claim 17.

19. The powdered paint composition for heat dissipation according to claim 7, wherein a content of the component (C) is 0.5 mass % or more and 30 mass % or less.
